(19) United States
(12) Patent Application Publication
(10) Pub. No.: US 2018/0009461 A1
(43) Pub. Date: Jan. 11, 2018

(54) Utility Carts

(71) Applicant: Raymond Rucker, Nashville, GA (US)

(72) Inventor: Raymond Rucker, Nashville, GA (US)

(21) Appl. No.: 15/644,558

(22) Filed: Jul. 7, 2017

Related U.S. Application Data
(60) Provisional application No. 62/359,618, filed on Jul. 7, 2016.

(51) Int. Cl. B62B 5/00; B62B 3/02

(52) U.S. Cl. CPC B62B 5/0003; B62B 3/022; B62B 2205/06

(57) ABSTRACT

The invention provides an improved mobile storage apparatus in which the deckplate of a collapsible rolling table is mated to the bottom panel of a detachable cargo compartment by an interlocking interface to limit sliding and detachment during transport. The apparatus further includes supplemental casters to facilitate loading the cargo compartment and or the entire folded unit onto a table or vehicle, and some embodiments can themselves be used as display tables.

### RELATED APPLICATIONS

This application claims priority to provisional U.S. Pat. App. No. 62/359,618, filed Jul. 7, 2016 and having the same sole inventor and title.

### FIELD OF THE INVENTION

This invention pertains to utility carts with improved designs for cargo transport and load transfer.

### BACKGROUND

Carts for carrying vendor displays to and from exhibitions and expositions are commonly bulky, heavy, or otherwise hard to carry, and manual tote containers suffer from some of the same drawbacks. Common examples of aids for this purpose include hand trucks, utility carts, boxes, boxes mounted on wheels located at four corners, boxes mounted on two wheels at one end, carts with scissor lifts, carts with hydraulic lifts, media carts, and the like. Generally these arrangements have at least one significant disadvantage. Many require heavy lifting when the fully loaded unit is placed onto a vehicle or table. Most require separate stowing of the cart and storage component. Still others require care to avoid slipping, sliding or tipping of a carton on a transport surface when the apparatus is in motion. As to this last factor, carpeted surfaces are often used to increase friction on weight bearing platforms, however these transfer spills onto boxes and brochures left there, can be hard to clean and dry, and can also cause rug burns.

Carts for use in expositions and exhibitions would ideally be light, collapsible, easily mobile, rugged yet quickly broken down to component modules, transferrable onto table tops and vehicle beds with little or no lifting, and with reduced risk of cargo slippage when the unit is in motion. Thus there is an ongoing need for improved utility carts.

### SUMMARY OF THE INVENTION

The invention provides utility carts that have improved stability, stowability, mobility, modularity, adaptability, and cargo transferability. In particular the invention provides carts that can lock onto the bottom of a cargo container in a sliding fashion or not, as preferred, and for which the cargo can be loaded onto tables and truck beds with a minimum of effort, including optionally with the cart attached in a collapsed form. In some embodiments the invention comprises a plurality of cargo compartments supported by the platform. In other embodiments the cart itself can be adapted to double as a display table.

In particular embodiments the invention provides a mobile storage apparatus comprising:

a) a collapsible rolling table, wherein:
i) the table comprises a deckplate and at least three legs;
ii) the deckplate has an underside that is attached to a deckplate support framework, at which framework each leg is hingeably mounted at the leg's respective first end, such that each leg may be folded toward or unfolded from the deckplate's underside;
iii) each leg is affixed to at least one caster upon which it rests when the table is upright and the leg is unfolded from the deckplate's underside; and
iv) the deckplate comprises an upper surface having a first mating profile;

b) a cargo compartment, wherein:
i) the cargo compartment comprises a bottom panel and is enclosed on at least two sides;
ii) the cargo compartment rests upon and is readily separable from the deckplate; and
iii) the bottom panel of the cargo compartment comprises a second mating profile that is complementary to the deckplate's first mating profile;

c) an interlocking interface that is defined by the first and second mating profiles when they are juxtaposed, such that the interface reduces sliding by the bottom panel in at least one direction relative to the deckplate yet permits ready removal of the cargo compartment; and

d) a plurality of supplemental casters that are mounted upon at least one of the the cargo compartment, deckplate, and the deckplate support framework.

### BRIEF DESCRIPTION OF THE DRAWINGS

FIG. 1 depicts a caricature of a non-limiting illustrative embodiment of some features according to the invention, for a mobile storage apparatus according to the invention for which the legs are fully unfolded.

FIG. 2 depicts a caricature of a non-limiting illustrative embodiment of some features according to the invention, for a mobile storage apparatus according to the invention being loaded onto a truck bed, where the legs are partially folded.

FIG. 3 depicts a caricature of a non-limiting illustrative embodiment of some features according to the invention, for a mobile storage apparatus according to the invention are full folded.

FIG. 4 depicts a caricature of a non-limiting illustrative embodiment of some features according to the invention, for a mobile storage apparatus according to the invention for which the legs are fully unfolded.

FIG. 5 depicts a caricature of a non-limiting illustrative embodiment of some features according to the invention, for a mobile storage apparatus according to the invention for which the legs are fully folded.

FIG. 6 depicts a caricature of a non-limiting illustrative embodiment of some features according to the invention, including for an interlocking interface of a mobile storage apparatus according to the invention.

### DETAILED DESCRIPTION OF THE INVENTION

In assessing needs for use in single-person cargo movement back and forth between vehicles and exhibit tables the inventor has found that modifications of gurney designs can serve the purpose. However, unlike medical gurneys cargo for exhibits are containers—sometimes tall—instead of a prone human patient who are strapped down and under the continual watchful eye of a medical professional. Because cargo transport has different requirements the rolling platform and the container both had to be adapted for the present purposes.

The claims and scope of the invention may be better understood by consideration of the following definitions and explanations for terms used herein and corresponding features of the invention.

The term “mobile storage apparatus” means units according to the invention in their assembled form.

The term “collapsible rolling table” means a table, having at its bottom wheels or a wheelbase, and for which the legs may be folded so that the table may be stowed in a compact form. The term “collapsible rolling table” as used herein does not necessarily mean that the table is in motion at any particular time, but means that the table has wheels by means of which it can be rolled across the ground.

The term “deckplate” means the tabletop for the collapsible rolling table. The shape of the deckplate may be rectangular, square, triangular, circular, oval, quarter-moon shaped, or have another shape. In a particularly preferred embodiment the deckplate is rectangular however the invention is not so limited. The deckplate may have a general shape—e.g., not just a surface topography but the shape of the deckplate itself—that is planar, convex, concave, curled upward or downward, wavy in one dimension, wavy in two dimensions, zigzag, crenellated, waffle-like, checkerboard-like, or another general shape. In a particularly preferred embodiment the deckplate material has a planar shape but the invention is not so limited. In certain embodiments the deckplate is perforated or otherwise defines orifices that pass from the upper surface to the underside of the deckplate. In some embodiments the deckplate, when the collapsible rolling table is up as the appearance of a grid or ladder laying on its side. Nevertheless regardless of whether or not the deckplate has perforations, other orifices, or channels passing from the upper surface to the underside of the deckplate, deckplates as employed in the invention have a mating profile on their upper surfaces. The invention is not limited by the composition of the deckplate, though the material should be sufficiently robust that the features of the mating profile retain their structural integrity and initial interlocking capacity under the conditions of ordinary use. Nonlimiting illustrative materials that may be used for the deckplate include metals, wood, wood composites, tough polymeric materials, and polymeric composites. In particularly useful embodiments the deckplate is formed from metal but the invention is not so limited.

The term “underside” as used with respect to a deckplate means its downward side when the collapsible rolling table is upright.

The term “upper surface” as used with respect to a deckplate means the upward side when the collapsible rolling table is upright.

The term “deckplate support framework” means a framework mounted on the underside of a deckplate, upon which other features may be provided such as handles, supplemental casters, axles for legs or separate hinges, parts for expanding and contracting a scissor mechanism, power-assisting devices, rims for the deckplate, loops for use in pulling the device with cables or ropes, and other useful components.

The term “orientation” as used with respect to a deckplate means its orientation relative to horizontal. Thus it may tilt downward toward one end, one side or one corner. In a particularly preferred embodiment the invention is horizontal but the invention is not so limited.

The term “more than five degrees different from horizontal along at least one axis” as used with respect to the orientation of a deckplate means that when the upper surface of the deckplate is averaged as planar, the steepest trigonometric angle defined by the plane relative to horizontal is at least five degrees.

The term “leg” as used with respect to apparati according to the invention means a leg of the collapsible rolling table. As used herein the term “leg” contemplates legs that are hinged, on hinges, extendable by telescoping, extendable by ratcheting, extendable by screwing, and or part of a scissor mechanism. The term leg is not limited by the shape, cross-section or composition of the leg, though they should enable the leg to have sufficient strength for long-term use under ordinary working conditions for the weight and use frequency contemplated. Nonlimiting illustrative materials that may be used for the deckplate include metals, wood, wood composites, tough polymeric materials, and polymeric composites. In particularly useful embodiments the leg is formed from metal but the invention is not so limited.

The term “first end” as used with respect to a leg means the top end, i.e., the end by which it is mounted to a deckplate.

The term “extendable” as used with respect to a leg means that it may be lengthened or shortened at the end by a means such as telescoping, ratcheting, or screwing. In particular embodiments extendable legs are held at a particular length by means of a clamp, compressible button, ratchet, or other reversible locking mechanism.

The term “scissor mechanism” has its ordinary meaning in the mechanical engineering arts, and means linked, folding supports in a criss-cross “X” pattern, also known as a pantograph. In some embodiments units according to the invention have two legs that share a common axel or hinge pin to define an “X”, and have two other legs that are identically linked to define an “X” in parallel.

The term “part of a scissor mechanism” as used with respect to a leg means that it defines one diagonal of the “X” in a scissor mechanism.

The term “hingeably mounted” as used with respect to a leg on a deckplate means that the one end of the leg is hinged to the deckplate, such that the leg is attached to but can rotate relative to the deckplate. In some embodiments a hingepin runs through the leg; in other embodiments the leg is affixed to a hingeplate; and in still other embodiments the leg is otherwise attached so as to move in a hinge-wise fashion. In certain embodiments the hinge is lockable in the extended and or closed position.

The term “folded toward or unfolded from” as used with respect to a leg on a deckplate's underside means that the hinge mount for the leg is folded to the closed position or respectively unfolded to the open position.

The term “caster” means a mounted wheel for rolling a device that is borne by the caster. The wheel may have a configuration such as disk-on-axle, ball-in-socket, or other wheel configuration. The wheel may have a protective fender or not. The wheel may have a tire or not. The caster may have a brake or not. The caster or wheel may be readily removable or not.

The term “affixed” as used with respect to a caster on a leg means that the caster is mechanically attached in a way that allocated weight from the leg to the caster. The term “directly affixed” as used with respect to a caster on a leg means that the caster is attached solely to that respective leg, as opposed to a wheel base that collectively supports several legs. Likewise the term “respective caster” as used with respect to a particular leg means that the caster is directly affixed to that leg.

The term “brake” as used with respect to a caster means a device such as a friction tab or other mechanism for slowing or stopping the motion of a wheel in the caster. The term “mounted with a releasable brake as used with respect to a caster means that the brake can be locked at full-on position easily when desired, and released easily when desired.

The term “wheel base” means a framework that supports three or more legs and that rests on three or more casters. The term “affixed to and supported by a wheel base” as used with respect to legs means that they are mechanically attached to the wheel based.

The terms “affixed” and “mechanically attached” are used synonymously herein and mean attachment in a permanent or semi-permanent way such as by screws, bolts, hinges, adhesive, brackets and the like.

The term “supplemental caster” means a caster that is located not at the bottom or end of a leg, but on the deckplate or cargo compartment. They are useful, for instance, when a mobile storage apparatus of the invention is wheeled to approach an elevated surface such as a tabletop or vehicle loading bed, thus the supplemental caster can make contact with that elevated surface. In particular embodiments brakes are then applied to the deckplate's supplemental casters, which support the weight of the entire unit while the legs are folded, after which the brakes are released and the collapsed apparatus is wheeled onto the elevated surface. Naturally the operation can be done in reverse. Similarly, a mobile storage apparatus may be rolled up to an elevated loading bed, where supplemental casters on for example the side of a cargo container may be placed on the elevated surface for a comparable operation. The latter application is useful, for instance where the same collapsible rolling table may be used to move several cargo containers in a row. Supplemental casters may optionally be different from casters bearing the legs with respect to wheel dimensions, wheel type, and wheel composition, though all casters should be sufficiently tough to allow long-term use under ordinary working conditions for the weight and use frequency contemplated. Nonlimiting illustrative materials that may be used for the wheels of any caster include metals, wood, wood composites, tough polymeric materials such as plastics and rubbers, as well as polymeric composites. In particularly useful embodiments the wheels are comprised of rubber and or a tough plastic but the invention is not so limited.

The term “mounted” as used with respect to supplemental casters on a component such as the deckplate or cargo compartment means that the casters are affixed to the component. In particularly preferred embodiments the casters are mounted at a position that allows for several inches of overlap between the bottom of the component and the loading surface, to avoid dropping the load when casters for the legs are not in contact with the ground.

The term “ground” as used with respect for surfaces upon which the collapsible rolling table rolls includes but is not limited to floors, sidewalks, parking lots, thresholds, and other surfaces on the ground.

The term “rests” as used with respect to one object on another means that the weight of the upper object is borne by the lower object.

The terms “upright” and “upright position” are used synonymously herein, and as used with respect to a table or apparatus according to the invention means that deckplate has the same orientation that it would have when the mobile storage apparatus is being rolled across the ground.

The term “cargo compartment” means a container that rests atop a collapsible rolling table, where the cargo compartment's bottom panel has a mating profile that is complementary to is and capable of being intimately interfaced with a mating profile on the top surface of the deckplate; this naturally requires that if one of the sides has a general shape as opposed to a surface topography—that is non-planar, then the other side has a complementary general shape at least to the extent that it affects the surface topography. In a non-limiting illustration, if the deckplate's upper surface is generally convex then the lower surface of the corresponding cargo compartment's bottom panel is generally concave. In some embodiments the cargo compartment has the shape of a rectangular box, in others it has the shape of a pill box, in still others it has a flat bottom and optionally top and its sides form a polygon, and in alternative embodiments the cargo compartment has yet a different shape. In certain embodiments a plurality of cargo compartments may simultaneously rest upon and have complementary mating profiles to the upper surface of the same deckplate. In various embodiments the interior of the cargo compartment comprises one or more dividers to create sections. In certain embodiments one or more corners or sides of the cargo compartment comprise a respective hinge such that the compartment is collapsible by folding inward. In some embodiments one or more sides is separable from neighboring sides and attached to the bottom panel by a hinge, such that the side may be folded outward; where this is true for all enclosed sides the collapsible rolling table may serve in its own right as an exhibit table. The term cargo compartment is not limited by the shape, size or composition of the cargo compartment, though they should enable the cargo compartment to have sufficient strength for long-term use under ordinary working conditions for the weight and use frequency contemplated. Nonlimiting illustrative materials that may be used for the deckplate include metals, wood, wood composites, tough polymeric materials, and polymeric composites. In particularly useful embodiments the cargo compartment is formed from rubber and or from a tough plastic such as a nylon, a high-melting polyalkylene, a polycarbonate, a polyacrylate, or another tough plastic, but the invention is not so limited. In particularly useful embodiments the cargo compartment has the form of a box or a bucket with a lid, but the invention is not so limited. An illustrative range for convenient cargo container dimensions include about 42±6 inches long by about 21±6 inches wide by about 18±6 inches high. However the invention is not so limited.

The term “bottom panel” as used with respect to a cargo compartment means the bottom side of the cargo compartment as defined herein. The term bottom panel is not limited by the shape, size or composition of the bottom panel, though they should enable the bottom panel to have sufficient strength for long-term use under ordinary working conditions for the weight and use frequency contemplated, and should further allow the features of the bottom panel's mating profile to retain their structural integrity and interlocking capacity under the contemplated conditions for use.

The term “side panel” as used with respect to a cargo compartment means a panel on a lateral side of the cargo compartment as defined herein. In various embodiments some or all of the side panels for an apparatus according to the invention may be planar, rounded, bent, or be otherwise configured. In certain embodiments a metal sheet is curved like a donut to form a monolithic circular or semi-circular side panel or bent to form an entire or partial polygon shape. In certain preferred embodiments the side panels are planar but the invention is not so limited.

The term “enclosed” as used with respect to a side of a cargo compartment means that a side panel is present and in position for that side. In certain preferred embodiments at least one side is not enclosed. The term “enclosed on all sides” as used with respect to a cargo compartment means that all sides are enclosed; in some particular embodiments this is the case.

The term “lid” as used with respect to a cargo compartment means a top-facing side panel on the compartment. The lid may be readily separable, may be hinged to a side panel, may be connected to side panels on all but one edge of the lid, or may be otherwise configured. In some embodiments the lid has a down-extending lip at one or more edges or corners of the lid to lap over or alternatively fit inside corresponding side panels.

The term “collapsible” as used with respect to a cargo compartment means that it may be quickly reduced in size. In some embodiments this is achieved by means of hinges such that the box is folded at one or more edges or other lines. In certain embodiments the collapse is facilitated by removing one or more sides or connectors between sides so as to stack the pieces. The term “collapsible” as used herein with respect to cargo compartments is not limited to any specific design, mechanism or means for collapsibility.

The term “box for which the sides may be removed” as used with respect to a cargo compartment means that its side panels may be readily separated from the bottom panel.

The term “box for which the sides may be independently folded out” as used with respect to a cargo compartment means its side panels are separable from one another and connected to the bottom panel by a hinge, such that each may be folded outward and optionally downward without respect to the others.

The term “end” as used with respect to the location of supplemental casters on a deckplate or cargo compartment means a lateral side in the direction toward which or from which the collapsible rolling table is normally pushed or pulled.

The term “side” as used with respect to the location of supplemental casters on a deckplate or cargo compartment means a side that is horizontally orthogonal to the direction toward which or from which the collapsible rolling table is normally pushed or pulled.

The term “corner” as used with respect to the location of supplemental casters on a deckplate or cargo compartment means the intersection of a side and an end, as those terms are defined herein respectively relative to the location of supplemental casters.

The term “edge” as used with respect to a cargo compartment means the intersection of any two faces, whether they are sides, bottom panel, lid or open top. The term “corner” as used with respect to a cargo compartment means the intersection of three or more such faces.

The term “rests upon” as used with respect to a cargo compartment on a deckplate means that the deck plate bears the weight of the cargo compartment.

The term “readily separable” as used with respect to separating a cargo compartment from a deckplate upon which it rests means that the separation may be accomplished quickly and without mechanical disassembly. In a non-limiting illustration the separation may be accomplished by lifting the cargo compartment or sliding it in one direction. In further non-limiting illustrations the separation may be accomplished after manually releasing one or more interface locking features, or after flipping a quick-release lever. The term “permits ready removal” as used with respect to separating a cargo compartment from a deckplate upon which it rests, means that they are readily separable.

The term “mating profile” means a characteristic topography for a surface. In non-limiting illustrative mating profiles physical features such as rails, studs or receptables are further defined by a general shape for the underlying material, such as a curve, wave or zigzag. In embodiments according to the invention deckplate's upper surface has a mating profile to which the cargo compartment bottom panel underside has a complementary mating profile, i.e., the two profiles can be juxtaposed to form an intimately corresponding interface.

The term “complementary” as used with respect to the first and second mating profile means that features on one can be mated with opposite corresponding features on the other, such as mating a peg to a hole, or mating a convex bump to a concave depression, or mating crenellated surfaces, or mating rails in grooves.

The term “interface” as used with respect to complementary mating profiles means the contours where the surfaces meet.

The term “interlocking interface” as used with respect to complementary mating profiles means that the interface inhibits movement relative to each other in at least one direction. For embodiments in which the interface is defined solely by rails and slots aligned in the same direction, the paired mating profiles may slide relative to one another in that direction but be interlocked in other lateral directions. For embodiments in which the interface includes, e.g., a waffle-shaped or checkerboard-shaped mating profile the paired mating profiles may be interlocked in all lateral directions but be separable by lifting. For embodiments in which the interface comprises rails having a T-shaped cross-section mated to grooves having a cross-section like an inverted T, such that when the rails are slid into the grooves they are locked into a place except in the direction of the slide, the paired mating profiles may be separable only by sliding along one lateral axis and not by lifting. For embodiments in which the interface comprises sturds having a T-shaped cross-section mated to grooves having a cross-section like an inverted T and arranged in a cross-hatch pattern, such that when the rails are slid into the grooves they are locked into a place except in the direction of the slide, the paired mating profiles may be separable only by sliding along the axes of cross-hatching, and optionally by design by lifting when the studs are located at the intersections of grooves. Further variations and designs for interlocking features will occur to persons of ordinary skill in mechanical engineering, and are contemplated by the present invention.

The term “juxtaposed” as used with respect to complementary mating profiles means placing them side by side such that corresponding opposite features are paired and in close proximity to one another.

The term “reduces sliding” with respect to motion of the bottom panel relative to the deckplate means that sliding for their respective near surfaces relative to one another is prevented or inhibited in at least one direction.

The term “rail” means a raised feature of approximately uniform height and having a large aspect ratio for the length relative to the width. The term “linear rail” means a rail that is essentially linear along its lengthwise direction.

The term “linear direction” as used with respect to sliding of an object on the upper surface of a deckplate means that the slide follows a linear path, as opposed to, for instance, sliding the same object on the deckplate surface in way that rotates the object.

The term “permits sliding in a particular linear direction” as used with respect to an interlocking interface means that the mating profiles that form that interface have no features that prevent sliding of the mating profiles relative to each other in that direction.

The term “circular” as used with respect to a rail on an interlocking surface means that the rail defines the circumference of a circle.

The term “semi-circular” as used with respect to a rail on an interlocking surface means that the rail defines the circumference of a semi-circle.

The terms “pivot” as used with respect to a cargo compartment on a deckplate means that is the cargo compartment is turned around there, for instance by spinning the cargo compartment in place while its bottom panel remains in contact with the deckplate's upper surface, or for instance by moving the center of the cargo compartment's bottom panel along an arc defined by features on the deckplate's upper surface while another point of the bottom panel remains in the same position relative to the deckplate.

The term “rotate” as used with respect to a cargo compartment moving about a point on the deckplate means that the cargo compartments moved along a circular arc, or is spun, in either case while the cargo compartment's bottom panel remains in contact with the deckplate's upper surface. Unlike the term “pivot” the term “rotate” as used herein does not require that any point of the cargo compartment remains in the same relative position relative to the deckplate.

The term “topography” as used with respect to an interlocking interface means the contours of its relative differences from planarity.

The term “waffle pattern” as used with respect to an interlocking interface means an interface in which a raised grid on one side is mated with a raised array of studs on the other side. In some embodiments the grid is in a cross-hatched pattern with two axes of lines. In other embodiments the grid has three or more axes of lines. In some embodiments the studs are cylindrical; in others they are raised squares or are other raised polygons.

The term “checkerboard pattern” as used with respect to an interlocking interface means a series of neighboring polygons that are alternately in raised form and lowered form. This includes, for example tessellated patterns of polygons, such as squares on a checkerboard if for instance the red squares were raised and the black squares were depressed, however as the term “checkerboard pattern” is used herein the term is not limited to patterns involved squares; comparable contrasting patterns include for instance hexagons in an alternating pattern, triangles in an alternating pattern, and the like. An alternative is where, for instance, some shapes differ in size or pattern or there are more than two typical heights; such topographies may be made, for instance by combinations of hexagons and triangles.

The term “stud-and-receptacle grid” as used with respect to an interlocking interface means that one or both mating profiles in a matched pair has an array of pins to which orifices that correspond in size, shape and location are provided by the other mating profile. As a non-limiting illustration, an array of pegs on a plane mated with a corresponding pegboard of receptacles provides a stud-and-receptacle grid as an interlocking interface.

The term “hill-and-valley grid” as used with respect to an interlocking surface means that one or both mating profiles in a matched pair has an array of protrusions to which depressions that correspond in size, shape and location are provided by the other mating profile.

The term “horizontal tab” as used with respect to an extension from a side, end, or corner of a deckplate or cargo compartment bottom panel means a mechanical tab protruding at that location.

The term “slot” as used with respect to receiving or retaining a tab from the other of a deckplate or cargo compartment bottom panel means a slot of appropriate size, shape, and location into which the tab may be inserted and where it optionally may be gripped.

The term “clamp” as used with respect to receiving or retaining a tab from the other of a deckplate or cargo compartment bottom panel means a clap of appropriate size, shape, and location into which the tab may be inserted and where it optionally may be gripped.

The term “receive” as used with respect to a tab from a deckplate or cargo compartment bottom panel means that the tab is inserted into the receiving element.

The term “retain” as used with respect to a tab from a deckplate or cargo compartment bottom panel means that the tab is gripped by retaining element.

The term “retractable pin” as used with respect to a mating profile means a protruding element such as a pin, stud, or other element having a large aspect ratio, that may be quickly, easily and reversibly withdrawn from its full height by manual or mechanical means. In particularly useful embodiments, a spring maintains the retractable pin at its full height when it is not in the process of being retracted.

The term “orifice” as used with respect to a mating profile receiving a retractable pin from another mating profile means a cavity into which the pin may be inserted.

The term “a power-assisting device” means a device that leverages manual power, mechanical power or electrical power to apply force with particular orientation. Non-limiting illustrations of power-assisting devices contemplated herein include motors, pneumatic devices, hydraulic devices, and manual cranks.

The term “raise the height of the deckplate from the collapsed position” as used with respect to a power-assisting device means that when the collapsible rolling table is in the upright position, the angle of at least one of its legs is altered in the direction of unfolding it, by means of power supplied from or otherwise by use of the power-assisting device, and the deckplate is raised in height as a result.

The term “rotating the angle of a leg” as used with respect to a power-assisting device means that the leg is rotated relative to its hinged connection on the deckplate, and that the rotation is achieved by means of power supplied from or otherwise by use of the power-assisting device.

The following terms have their usual and ordinary respective meanings in the engineering arts with respect to power use: “motor”, “pneumatic”, “hydraulic”, “manual” and “crank”. The term “pneumatic device” means a device that applies power by a pneumatic means such as but not limited to a piston for compressed air. The term “hydraulic device” means a device that applies power by a hydraulic means such as but not limited to a hydraulic pump for a pressurized fluid.

The term “height that can be adjusted” as used with respect to a collapsible rolling table means that the height of the deckplate can be adjusted readily within a particular height range.

The term “standard height range” as used with respect to a height for a particular type of surface means the range that is usual for that particular type of surface, whether by regulation, historical industry practice, or necessity for the type of activities performed there. The term “within six inches of” as used with respect to a standard height range means the range from six inches below the lower end of the standard height range to six inches above the higher end of the standard height range. A non-limiting illustrative standard height range for exhibition tables is from 22 to 36 inches, for which subsets of about 22 inches (for children), 29-30 inches (for standard table heights) and 36 inches (countertop heights) are recognized, e.g., for adjustable-height tables. A non-limiting illustrative standard height range for pick-up truck beds is 26 to 58 inches. A non-limiting illustrative standard height range for loading docks is 48 to 55 inches. Non-limiting illustrative typical height ranges for various delivery trucks are shown below, as specified for instance by Loading Dock Supply, LLC.

| | Truck Bed Height |
|---|---|
| Type of Truck | Total Range |
| Double Axel Semi | 45″-55″ |
| City Delivery | 45″-48″ |
| Container | 55″-62″ |
| Flatbeds | 47″-62″ |
| Furniture Van | 23″-36″ |
| High Cube Van | 35″-43″ |
| Low Boys | 19″-25″ |
| Panel Truck | 19″-25″ |
| Refrigerated (“Reefer) | 50″-60″ |
| Stake Truck | 42″-48″ |
| Step Van | 19″-30″ |
| Straight Semi | 48″-52″ |

The term “exhibition table” means a table of a type that is commonly used for exhibits by vendors at trade shows.

The term “pick-up truck” has its usual and ordinary meaning in the art of commercially available vehicles.

The term “bed” as used with respect to a pick-up truck means the upper surface of the cargo floor in the rear portion of a pick-up truck.

The term “tailgate” as used with respect to a pick-up truck means the door at the rear of a pick-up truck, that when opened provides additional access to the truck's cargo floor. Some tailgates are hinged at one side, and some are hinged at the lower edge. The term “open tailgate” means that the tailgate is in an open position. The term “top surface” as used with respect to a pick-up truck's bed or open tailgate refers to the top surface of a tailgate that is hinged at its lower edge and is in a fully open position.

The term “delivery van” means a van of a type that is used for delivering packages and other shipped items. The term “loading floor” as used with respect to a delivery van means the floor of the interior of the van, where packages or other goods are typically stored or transported in the van by placing or stacking upon such a floor.

The term “tractor-trailer combination”, also known as a semi-trailer and an eighteen-wheeler, has its usual and ordinary meaning in the shipping industry.

The term “trailer floor” means as used with respect to a tractor-trailer combination means floor of the interior of the trailer, where packages or other goods are typically stored or transported in the trailer by placing or stacking upon such a floor.

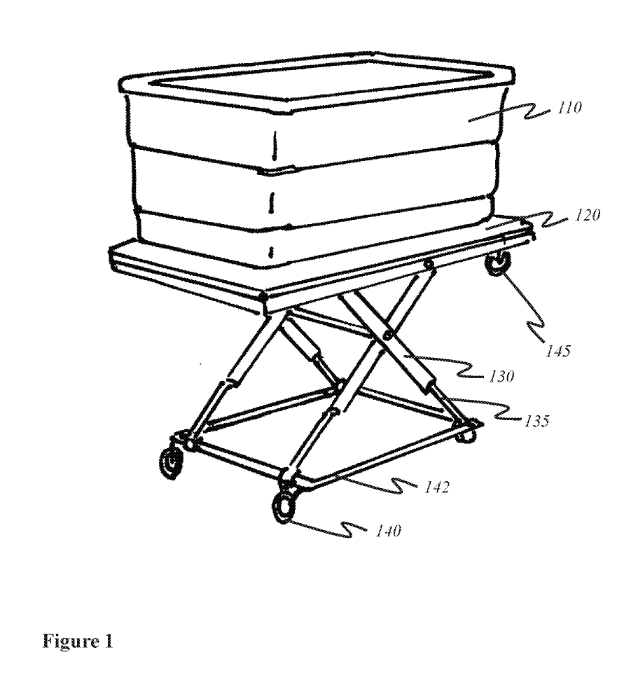

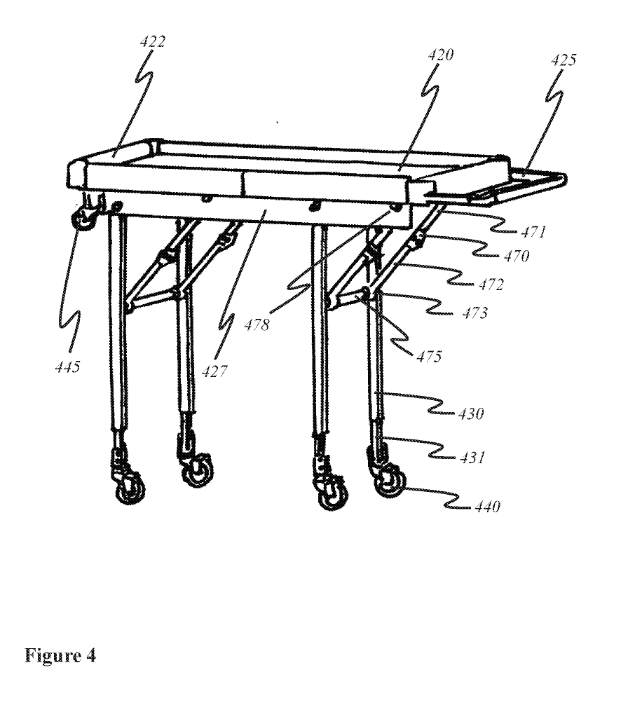

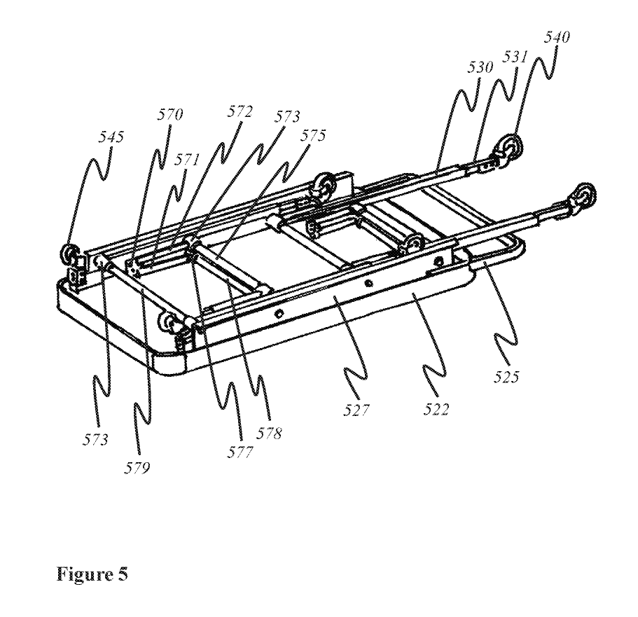

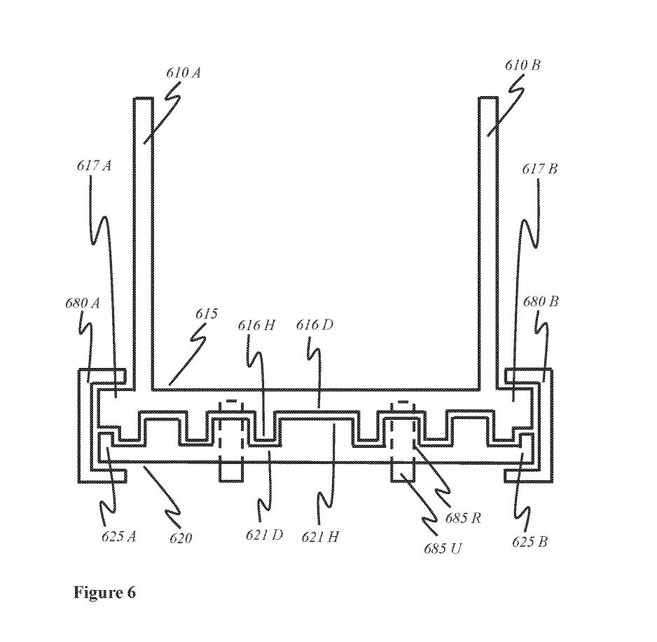

The invention may be further understood by reference to the drawings. Referring now to FIGS. 1, 2 and 3, these show certain embodiments of the mobile storage apparatus according to the invention, and particularly illustrate use of collapsible rolling tables comprising scissor mechanisms; for the sake of visual clarity in illustrating other features the mating profiles and their interface are not depicted though they are present. FIGS. 4 and 5 show alternative embodiments that employ a traditional straight leg format for folding tables; here also the mating profiles and their interface are not depicted, for the sake of visual clarity, though they are present. FIG. 6 shows several features of the interface between the cargo compartment and deckplate, including a non-limiting illustrative mating profile.

As to FIG. 1, cargo compartment 110 rests on deckplate 120, upon which supplemental casters are mounted at one end as for 145. The deckplate is supported by four legs that comprise part of a scissor mechanism; one of the legs, 130, is labeled. Each leg is extendible; the extension, 135, for one of the legs is labeled. The legs rest upon casters for which one is labeled, 140; in the embodiment shown the casters are mounted not directly on respective legs but on a wheel base, 142.

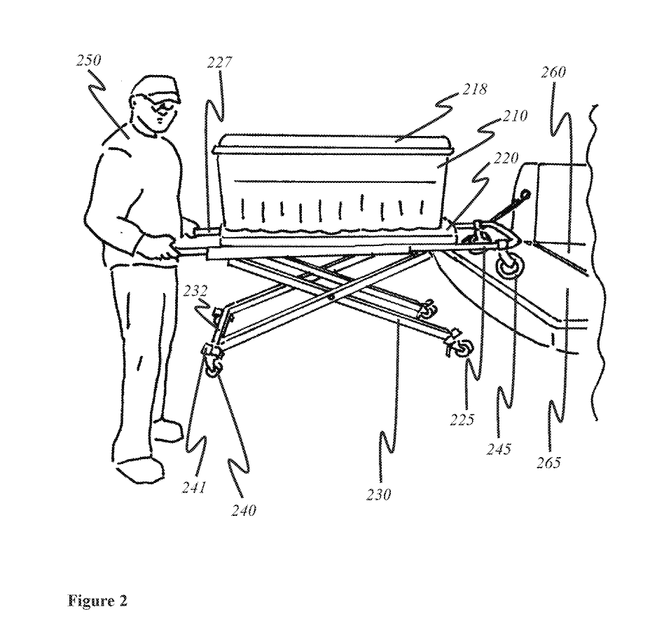

FIG. 2 illustrates use of the invention when it is in a semi-collapsed form while a user 250 manipulates it at a time when it is intermediate between the invention's transport in a vehicle and the invention's use on the ground. Here cargo compartment 210, which is capped by lid 218, rests on deckplate 220, upon which supplemental casters are mounted at one end as for 245. In this instance the deckplate rests on a support framework 225 that includes handles for which one (227) is labeled. The support framework is supported by four legs that comprise part of a scissor mechanism. One of the legs, 230, is labeled, as is a stabilizing crossbar 232 at the end near the user. In the drawing the supplemental casters rest on the tailgate 265 of a pick-up, and are off the pick-up truck bed 260. The casters associated with the legs, for which 240 is an example, are off the ground; those casters are also equipped with brakes, for which 241 is an example.

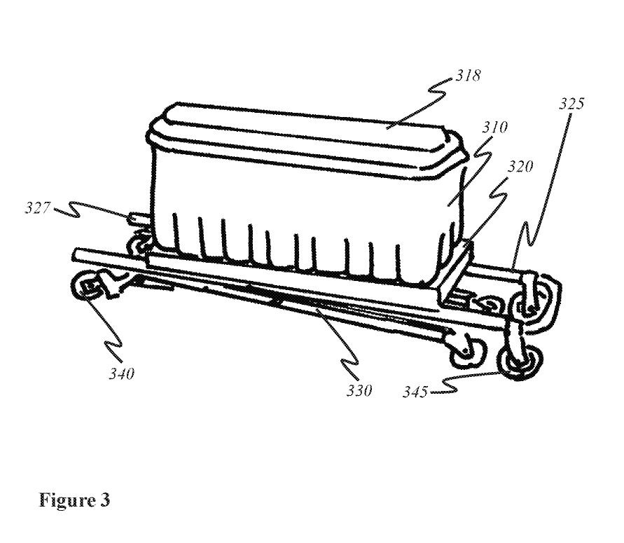

FIG. 3 illustrates the invention from an upper front corner view when the apparatus is in its fully collapsed form. Certain of the features are more visible than the rest from this angle. Cargo compartment 310, which is capped by lid 318, rests on deckplate 320, upon which supplemental casters are mounted at one end as for 345. In the embodiment shown the deckplate rests on a support framework 325 that includes handles for which one (327) is labeled. A folded-down leg 330 from a scissor mechanism is visible from the side, as a caster 340 that is mounded upon it.

FIG. 4 illustrates a top corner view collapsible rolling table for use with the invention when the table is in its fully unfolded form. Here the cargo compartment is not shown in order that the features associated with deckplate 420 may be more fully appreciated. In this particular embodiment the deckplate is equipped with a rim 422 and handle 425, and is borne by a support framework 427 that bears supplemental casters such as 445 at the end opposite the handle. The legs such as 430 have extensions such as 431 and associated casters such as 440. The use of hinges for the legs may be appreciated. In the embodiment shown a hinge is provided having an upper beam 471 and lower beam 472 linked to one another by a hinge plate 470. The lower beam is rotatable about an axle 475 by a spool 473. The upper beam is attached to the support framework by means of another axle, which here is manifest by the nut 478 that is on the outside of the support structure.

FIG. 5 illustrates an underside corner view of a collapsible rolling table for use with the invention when the table is in its fully folded form. Here the cargo compartment is not shown so that the support features may be more fully appreciated. In this particular embodiment a deckplate rim 522 is visible as is a handle 525 and a support framework 527 that bears supplemental casters such as 545 at the end opposite the handle. The legs such as 530 have extensions such as 531 and associated casters such as 540. The use of hinges for the legs may be appreciated. In the embodiment shown a hinge is provided having an upper beam 571 and lower beam 572 linked to one another by a hinge plate 570. The lower beam is rotatable about an axle 575 by means of a spool 573. The upper beam is attached to the support framework by means of a rotatable spool 577 mounted on axle 578. Leg 530 further rotates at one end upon a spool 573 that is rotatable about axle 579.

No considering FIG. 6, various features of the interface and connections between the cargo compartment and deckplate are shown for a particular embodiment of the invention. Here two enclosed sides, 610 A and 610 B are shown for the cargo compartment, as is the bottom panel 615, which has a mating profile with raised features such as 616 H and depressed features such as 616 D. The bottom panel further has tabs 617 A and 617 B that extend laterally outward and for which C-clamps 680 A and 680 B respectively hold them against deckplate 620 at its corresponding tabs 625 A and 625 B. The deckplate's mating profile is a counterpart to that of the bottom panel, such that recessed feature 621 D and raised feature 621 H mesh with the contours of 616 H and 616 D, respectively. Further shown are retractable pins, for which one is labeled at its visible part 685 U and inserted part 685 R.

In a particular embodiment the invention provides a cargo container reversibly integrated with a collapsible rolling table. In certain variations the table has a scissor mechanism for the legs, in other variations the legs fold only at one end but may be fortified with a hinged brace. At a minimum, when the integrated apparatus is upright the collapsible rolling table provides at least two positions, one at a minimum height and one at a maximum height. The top of the deckplate and the bottom of the cargo container can be interlocked, e.g., by means of a sliding rail or, e.g., by means of complementary grids having stud-and-receptacle fits or complementary waffle or checkerboard fits. Where the interlocked mechanism is slidable, the invention further allows for but does not require a locking feature such as a clamp or peg-and-receptacle type of latch. In addition the invention provides one or more support features optionally bearing casters—in order to lodge the integrated device stably against a table or truck bed while the scissor cart is being collapsed for convenient stowing.

In particular embodiments the invention further includes a device such as a pneumatic cylinder in order to facilitate expanding or contracting the scissor mechanism or folding one or more legs.

In addition, convenient heights for the support platform height for the scissor cart in an upright position include about three feet high as for table heights, and also in the standard ranges for bed heights for delivery vehicles, such as for sport utility vehicles, minivans, cargo vans, moving vans, pick-up trucks and their open tail gates, delivery trucks of all types, trailers in tractor-trailer combinations, automobile trailers, and the like.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1) A mobile storage apparatus comprising:
a) a collapsible rolling table, wherein:
i) the table comprises a deckplate and at least three legs;
ii) the deckplate has an underside that is attached to a deckplate support framework, at which framework each leg is hingeably mounted at the leg's respective first end, such that each leg may be folded toward or unfolded from the deckplate's underside;
iii) each leg is affixed to at least one caster upon which it rests when the table upright and the leg is unfolded from the deckplate's underside; and
iv) the deckplate comprises an upper surface having a first mating profile;
b) a cargo compartment, wherein:
i) the cargo compartment comprises a bottom panel and is enclosed on at least two sides;
ii) the cargo compartment rests upon and is readily separable from the deckplate; and
iii) the bottom panel of the cargo compartment comprises a second mating profile that is complementary to the deckplate's first mating profile;
c) an interlocking interface that is defined by the first and second mating profiles when they are juxtaposed, such that the interface reduces sliding by the bottom panel in at least one direction relative to the deckplate yet permits ready removal of the cargo compartment; and
d) a plurality of supplemental casters that are mounted upon at least one of the cargo compartment, deckplate, and the deckplate support framework.

2) The mobile storage apparatus according to claim 1 wherein the cargo compartment is enclosed on all sides.

3) The mobile storage apparatus according to claim 1 wherein the cargo compartment further comprises a lid.

4) The mobile storage apparatus according to claim 1 wherein the cargo compartment is collapsible.

5) The mobile storage apparatus according to claim 1 wherein the cargo compartment comprises a box for which the sides may be removed or independently folded out.

6) The mobile storage apparatus according to claim 1 wherein the supplemental casters are mounted on at least one end or side of the deckplate.

7) The mobile storage apparatus according to claim 1 wherein the supplemental casters are mounted on at least one end or side of the cargo compartment.

8) The mobile storage apparatus according to claim 1 wherein at least one of the legs is extendable.

9) The mobile storage apparatus according to claim 1 wherein the legs are part of a scissor mechanism.

10) The mobile storage apparatus according to claim 1 wherein each leg is directly affixed to and supported by a respective caster.

11) The mobile storage apparatus according to claim 1 wherein the legs are affixed to and supported by a wheel base.

12) The mobile storage apparatus according to claim 1 wherein the collapsible rolling table further comprises a power-assisting device to raise the height of the deckplate from the collapsed position by rotating the angle of at least one leg, and the power assisting device is selected from the group consisting of motors, pneumatic devices, a hydraulic devices, and manual cranks.

13) The mobile storage apparatus according to claim 1 wherein the interlocking interface comprises at least one linear rail and permits sliding of the cargo compartment in a particular linear direction on the upper surface of the deckplate.

14) The mobile storage apparatus according to claim 1 wherein the interlocking interface comprises a circular or semi-circular rail and permits pivoting of the cargo compartment to rotate it about a point on the deckplate.

15) The mobile storage apparatus according to claim 1 wherein the interlocking interface prevents sliding in any direction and has a topography selected from the group consisting of a waffle pattern, a checkerboard pattern, a stud-and-receptacle grid, and a hill-and-valley grid.

16) The mobile storage apparatus according to claim 1 wherein at least one of the deckplate and cargo compartment bottom panel comprises a horizontal tab extending from a side, end or corner and the other of the deckplate and cargo compartment bottom panel comprises a slot or clamp for receiving and retaining the tab.

17) The mobile storage apparatus according to claim 1 wherein at least one of the first and second mating profile comprises a retractable pin, and wherein the other mating profile defines an orifice to receive the pin.

18) The mobile storage apparatus according to claim 1, wherein when the apparatus is in an upright position, the orientation of the deckplate is more than five degrees different from horizontal along at least one axis.

19) The mobile storage apparatus according to claim 1, wherein at least one caster is mounted with a releasable brake.

20) The mobile storage apparatus according to claim 1, wherein the collapsible rolling table has a height that can be adjusted such that the bottom of the deckplate is within six inches of a standard height range for at least one of the following when it is on a level surface: an exhibition tabletop; the top surface of a bed of a pick-up truck; the top surface of an open tailgate of a pick-up truck; the loading floor of a delivery van; the trailer floor of a tractor-trailer combination; and a loading dock.
